(19) United States
(12) Patent Application Publication
(10) Pub. No.: US 2007/0210778 A1
(43) Pub. Date: Sep. 13, 2007

(54) Current controlled swithching regulator

(76) Inventor: D.N. Radha Krishna, Bangalore (IN)

Correspondence Address: WAGNER, MURABITO & HAO LLP, Third floor, Two North Market Street, San Jose, CA, 95113, US

(21) Appl. No.: 11/654,711

(22) Filed: Jan. 17, 2007

Related U.S. Application Data
(60) Provisional application No. 60/779,148, filed on Mar. 2, 2006.

(51) Int. Cl. G05F 1/00

(52) U.S. Cl. 323/284

(57) ABSTRACT

Systems and methods for current controlled switching voltage regulators. In one embodiment of the present invention, a voltage regulator device comprises a switching stage for selectively charging an output voltage and a current control mechanism to limit a range of voltages for controlling the switching stage. In one embodiment, a switching circuit provides a drop in threshold voltage of the voltage regulator such that the voltage regulator no longer switches rail to rail but instead switches at a value lower than rail to rail. The current control mechanism may include an output driver of a comparator, the comparator is for producing a control signal for controlling the switching stage. In one embodiment, an activation circuit may activate the current control circuit when the supply voltage is above a certain threshold. Accordingly, the output voltage is kept substantially constant even when the supply voltage varies, thereby increasing its operable range.

### RELATED APPLICATIONS

This application claims the benefit of a provisional application Ser. No. 60/779,148 with attorney docket No CYPR-CD05032.PRO, inventor D. N. Radha Krishna, entitled “CURRENT CONTROLLED SWITCHING REGULATOR” that was filed on Mar. 2, 2006. This application further claims the benefit of an Indian application serial No. 71/CHE/2006, inventor D. N. Radha Krishna, entitled “CURRENT CONTROLLED SWITCHING REGULATOR” that was filed on Jan. 17, 2006. The above-cited applications are incorporated herein in their entirety.

### TECHNICAL FIELD

Embodiments of the present invention relate to the field of electronics. More particularly, embodiments of the present invention relate to systems and methods for current control of switching voltage regulators.

### BACKGROUND

Voltage regulators are generally designed to maintain a constant voltage level. A conventional switching regulator generally comprises a switching element that turns on/off in response to a comparison between the output signal and a known reference signal.

The control input of the switching element, e.g., a gate of a p-type metal oxide semiconductor (PMOS), generally switches between a supply voltage (e.g., V_{cc}) and ground. For example, the control input of the switching element opens the switching element in order to charge the regulated voltage when the regulated output is less than the known reference voltage. Similarly, the control input of the switching element closes the switching element in order to discharge the regulated voltage when the regulated output is above the known reference voltage.

Unfortunately, when the supply voltage varies, the voltage applied to the switching element also varies, producing a varying rate of charge to the regulated output. The varying rate of charge to the regulated output generally induces undesirable voltage variation, e.g., ripple, onto the regulated output. Frequently, the amount and/or frequency of the ripple varies with changes in the supply voltage, thereby increasing the difficulty of filtering such ripple.

Conventionally, ripples were contained by designing faster comparators. However, the speed of the comparator is limited by the size of the switch used to be driven by the comparator. Generally, the size of the switch can be huge depending on the headroom requirements. Accordingly, designing a faster comparator does not provide a complete solution, and particularly in design systems where headroom is limited.

Moreover, faster comparators use more power. Accordingly, faster comparators are not suitable for low power (e.g., battery) applications (e.g., MoBL RAMs). Furthermore, faster comparators that use more power produce more ripple at higher voltages. To remedy the increase in ripple, additional circuitry is used for different voltage ranges. As a result, the cost of manufacturing a voltage regulator increases. Moreover, using additional circuitry reduces valuable die surface which can otherwise be used by the chip and its applications.

### SUMMARY

Accordingly, a need has arisen to provide a voltage regulator for controlling variation in voltage (e.g., ripple) without being constrained by the size of the switch, e.g., headroom requirements, used by the comparator. Moreover, a need has arisen to provide a voltage regulator for controlling ripple without using additional power, thereby suitable for low power applications (e.g., battery operable). Furthermore, a need has arisen to provide a voltage regulator for controlling ripple without increasing the manufacturing cost. Moreover, a need has arisen to provide a voltage regulator for controlling ripple without substantially impacting valuable die surface while widening the voltage range of operation for a given comparator speed. It will become apparent to those skilled in the art in view of the detailed description of the present invention that embodiments of the present invention remedy the above mentioned needs.

In one embodiment of the present invention, a voltage regulator device comprises a switching circuitry for selectively charging an output voltage and a current control circuit to limit a range of voltages for controlling the switching circuit. In one embodiment, the current control circuit comprises a plurality of transistors, wherein at least one of the transistors acts as a crude current source at higher voltages. According to one embodiment of the present invention, at least one of the transistors provides for a drop in the threshold voltage of the switching circuit of the voltage regulator. As a result, the overdrive of the switch for the comparator no longer fluctuates rail to rail but instead fluctuates at a value smaller than rail to rail, thereby reducing ripple at higher voltages. Moreover, the voltage regulator behaves normally at low voltages. As a result, the voltage range of the switching regulator is widened by the addition of a few transistors. Moreover, ripple is maintain substantially constant over a wide voltage range for a given comparator speed. Furthermore, addition of a few transistors uses very little valuable die surface and without substantially increasing its manufacturing cost.

More specifically, one embodiment of the present invention relates to a voltage regulator device including a first circuit that includes a comparator for comparing an output signal to a reference signal; and a first switch coupled to the comparator for switching responsive to the comparison; a second circuit, coupled to the first circuit, for controlling the first circuit such that the first circuit is switched at a value smaller than rail to rail; and a third circuit, coupled to the second circuit, for switchably controlling the resistance of the third circuit to control the output signal such that the output signal remains substantially constant, when the first switch is closed, independent from the supply voltage of the first switch. In one embodiment of the present invention, the second circuit is operable to provide a drop in a threshold voltage of the first switch such that the first circuit is switched at a value smaller than rail to rail. According to one embodiment of the present invention the second circuit comprises a p-type metal oxide semiconductor (PMOS) transistor or an n-type metal oxide semiconductor (NMOS) transistor or any combination thereof.

In one embodiment of the present invention, the first switch comprises a p-type metal oxide semiconductor (PMOS) transistor. According to one embodiment of the present invention the resistance of the third circuit decreases when the supply voltage of the first switch increases such that the third circuit behaves as a current source. In one embodiment, the third circuit comprises a p-type metal oxide semiconductor (PMOS) transistor.

Embodiments include the above and wherein the voltage regulator device further includes a fourth circuit, coupled to the third circuit, operable to control activation of the third circuit at a voltage above a minimum threshold voltage. According to one embodiment, the fourth circuit comprises an n-type metal oxide semiconductor (NMOS) transistor coupled to a plurality of resistor components, wherein values of the NMOS transistor and the plurality of resistor components are operable to set the threshold which activates the third circuit.

### BRIEF DESCRIPTION OF THE DRAWINGS

present invention is illustrated by way of example, and not by way of limitation, in the figures of the accompanying drawings and in which like reference numerals refer to similar elements and in which:

FIG. 1 shows an exemplary block diagram of a voltage regulator in accordance with one embodiment of the present invention.

FIG. 2 shows a first portion of a voltage regulator in accordance with one embodiment of the present invention.

FIG. 3 shows a second portion of a voltage regulator circuit in accordance with one embodiment of the present invention.

FIG. 4 shows an exemplary flow diagram for maintaining substantially a constant ripple in a voltage regulator in accordance with one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### Current Controlled Switching Regulator

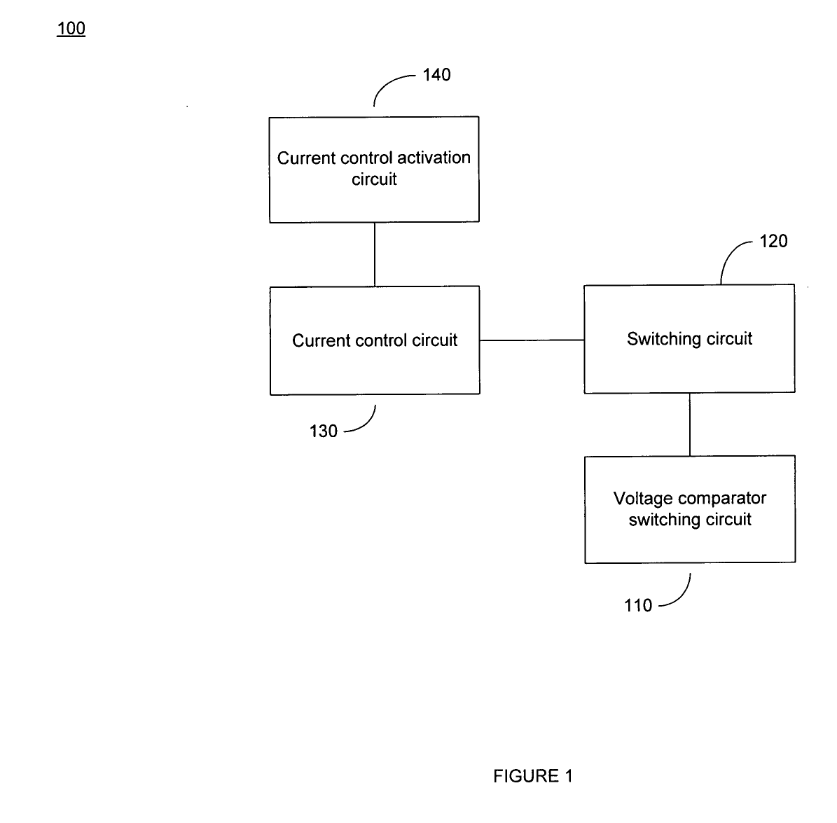

Referring now to FIG. 1, an exemplary block diagram 100 of a voltage regulator in accordance with one embodiment of the present invention is shown. In one embodiment of the present invention, the voltage regulator 100 comprises a voltage comparator switching circuit 110 coupled to a switching circuit 120 which may be further coupled to a current control circuit 130. Optionally, the current control circuit 130 may be coupled to a current control activation circuit 140.

In one embodiment of the present invention, the voltage comparator switching circuit 110 compares the output voltage to a reference voltage. When the output voltage is greater than the reference voltage a switch is tuned on. Similarly, when the output voltage is below the reference voltage the switch is turned off. Accordingly, the output voltage is selectively charged and discharged. However, using a switch to charge and discharge the output voltage causes the switch to fluctuate from rail to rail. For example, the switch may switch between 0 and V_{CC}. Accordingly, when the supply voltage to the switch varies, the rail to rail of the switch also varies. Therefore, increasing the supply voltage increases the ripple in the circuit. In order to control the overdrive of the voltage comparator switching circuit 110, the switching circuit 120 may be used.

Referring still to FIG. 1, the switching circuit 120 may be used to control the overdrive of the voltage comparator switching circuit 110 by providing a drop which is more than its threshold voltage. The switching circuit 120 causes the voltage comparator switching circuit 110 to switch at a value lower than rail to rail. Accordingly, the switching circuit 120 behaves like a diode and provides a drop in voltage. In one embodiment, the voltage regulator may comprise the voltage comparator switching circuit 110 and the switching circuit 120 when zero overdrive is needed. In comparison, in embodiments where an overdrive above zero is desired, the current control circuit 130 may be used and coupled to the switching circuit 120.

The current control circuit 130 along with the switching circuit 120 is a circuit that behaves like a crude current source at higher supply voltages. In other words, the resistance of the current control circuit 130 decreases when supply voltage increases, thereby the current control circuit 130 along with 120 behaves like a crude current source. Accordingly, when the supply voltage increases, the current control circuit 130 provides an additional drop in voltage that can be used to control the resistance of the switching circuit 110. Therefore, increasing the supply voltage is compensated for and the output voltage is remained substantially constant independent from the supply voltage. Accordingly, the ripple for a given comparator speed is maintained substantially constant independent from the supply voltage.

In one embodiment, the current control circuit 130 may be active for all voltage ranges. However, in some applications it is desirable to activate the current control circuit 130 at a certain threshold voltage, thereby keeping the current control circuit 130 inactive at lower voltages. In applications where activation of the current control circuit 130 at a certain threshold voltage is desired, the current control activation circuit 140 may optionally be coupled to the current control circuit 130. In one embodiment, the current control activation circuit 140 is designed to activate the current control circuit 130 when the supply voltage is above a given threshold voltage.

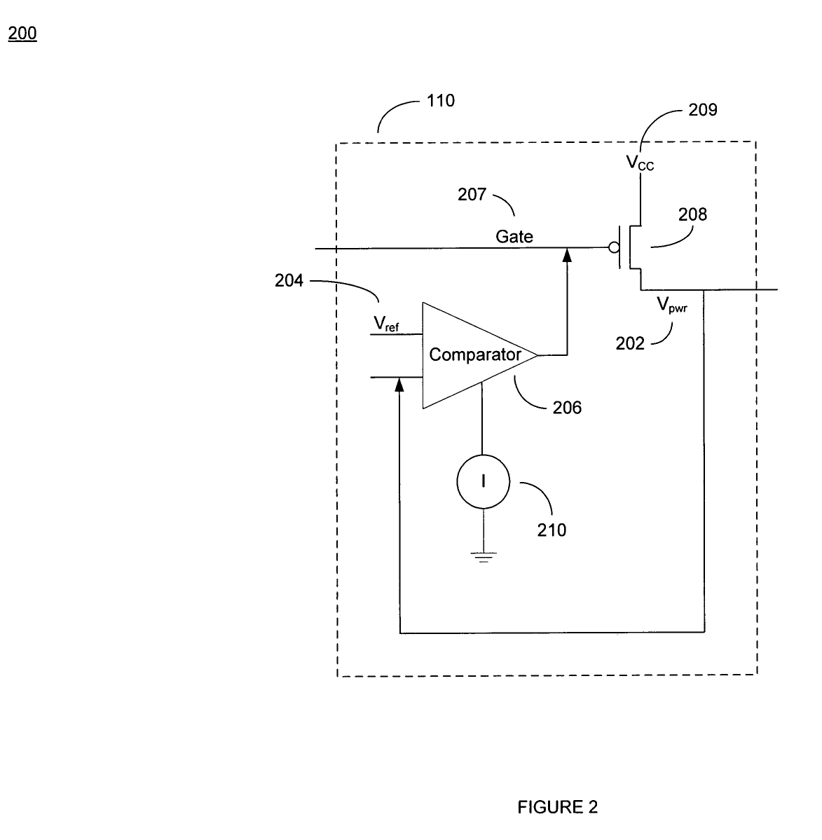

Referring now to FIG. 2, a first portion of a voltage regulator 100 in accordance with one embodiment of the present invention is shown. The first portion of a voltage regulator 200 in accordance with one embodiment of the present invention is the voltage comparator switching circuit 110 as described above. In one embodiment, the voltage comparator switching circuit 110 may comprise a p-type metal oxide semiconductor (PMOS) 208 transistor which is coupled to a comparator 206. The PMOS transistor 208 has a source V_{CC} 209, a gate 207 and a drain V_{PWR} 202.

It is appreciated that according to one embodiment of the present invention, the output voltage, e.g., the drain V_{PWR} 202 may be sample (not shown) and provided as an input to the comparator 206. According to one embodiment of the present invention, the output voltage V_{PWR} 202 is compared to a reference voltage, e.g., V_{ref} 204. Upon comparing the output voltage V_{PWR} 202 and the reference voltage V_{ref} 204, the comparator outputs a signal which is coupled to the gate 207 of the PMOS transistor 208.

Accordingly, when the comparator 206 determines that the output voltage V_{PWR} 202 is greater than the reference voltage V_{ref} 204, the gate signal 207 is asserted high. As such, the PMOS transistor 208 closes. Similarly, when the comparator 206 determines that the output voltage V_{PWR} 202 is less than the reference voltage V_{ref} 204, the gate signal 207 is asserted low. As such, the PMOS transistor 208 selectively charges and discharges. It is appreciated that the comparator 206 may be further coupled to a biasing current “I” 210 in pulldown stack of comparator final output driver.

Accordingly, the source of PMOS device 208 is coupled to supply voltage V_{CC} and the second terminal of PMOS device 208 provides a regulated voltage output V_{PWR}, node 202. A reactive device, e.g., a capacitor, is optionally coupled to regulated voltage output V_{PWR} (not shown), node 202.This capacitor can be realized from the capacitive property of the load.

It is appreciated that the PMOS transistor 208 switches between 0 and V_{CC}, thereby the output voltage switches rail to rail. As discussed above, increasing the supply voltage V_{CC} 209 increases the amount of ripple in the circuit. Therefore, as discussed-above to compensate for the ripple at higher voltages the switching circuit 120, and optionally the current control circuit 130 and its activation circuit 140 may be coupled to the voltage comparator switch circuit 110.

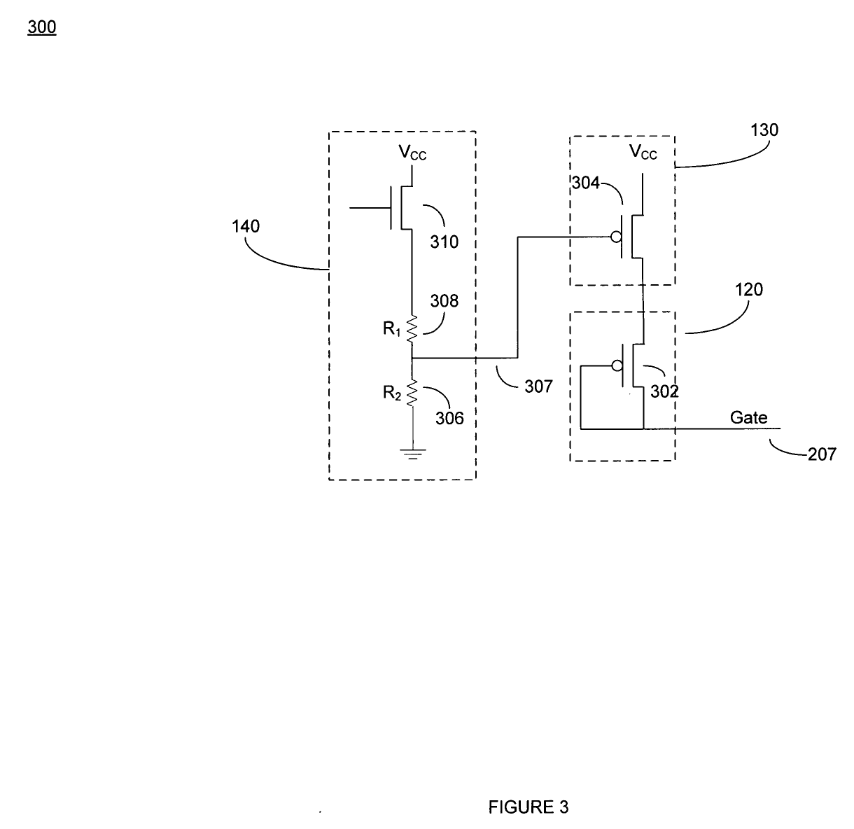

Referring now to FIG. 3, a second portion of the voltage regulator 100 circuit in accordance with one embodiment of the present invention is shown. The second portion 300 of the voltage regulator circuit in accordance with one embodiment of the present invention is the switching circuit 120, the current control circuit 130 and the current control activation circuit 140 that were described above.

As described above, the switching circuit 120 may be used to control the overdrive of the voltage comparator switching circuit 110 by providing a drop which is more than its threshold voltage. The switching circuit 120 causes the voltage comparator switching circuit 110 to switch at a value lower than rail to rail. In one embodiment of the present invention, the switching circuit 120 may comprise at least one PMOS 302 transistor. According to one embodiment of the present invention, the drain and the gate of the switching circuit 120 are coupled together. Moreover, the drain 207 of the PMOS 302 transistor is coupled to the gate 207 of the PMOS 208 transistor.

As described above, the PMOS 302 transistor behaves as a diode and provides a voltage drop which is more than its threshold voltage, thereby causing the voltage comparator switching circuit 110 to switch at a value lower than rail to rail. The source-gate voltage of the PMOS transistor 208 in the voltage comparator switching circuit 110 is given by the following relationship:
V_{SG}(device 208)=V_{CC}−V_{SG}(device 302) equation (1)
Accordingly, the PMOS transistor 208 of the voltage comparator switching circuit 110 no longer switch rail to rail but instead switches at a value, e.g., V_{SG}(device 302), lower than rail to rail, thereby switches between V_{CC} and the value given by equation (1). Therefore, the amount of ripple in the voltage regulator circuit is reduced.

It is appreciated that the voltage regulator circuit 100 comprise the voltage comparator switching circuit 110 and the switching circuit 120 when zero overdrive for the PMOS 208 transistor can be tolerated. However, in embodiments where zero overdrive for the PMOS 208 transistor cannot be tolerated, the current control circuit 130 may be used and coupled to the switching circuit 120.

As described above, the current control circuit 130 along with the switching circuit 120 in accordance with one embodiment of the present invention behaves like a crude current source at higher supply voltages. In other words, the resistance of the current control circuit 130 decreases as the supply voltage increases. As a result, the current control circuit 130 along with the switching circuit 120 behaves like a crude current source. Accordingly, when the supply voltage increases, the current control circuit 130 provides an additional drop in voltage, thereby controlling the overdrive of the transistor 208 and maintaining substantially a constant output voltage independent from the supply voltage. As a result, the ripple for a given comparator speed is maintained substantially constant independent from the supply voltage.

In one embodiment of the present invention, the current control circuit 130 comprises at least one PMOS 304 transistor. The resistance of the PMOS 304 transistor according to one embodiment of the present invention decreases as the supply voltage, e.g., V_{CC}, increases. In one embodiment of the present invention the drain of the PMOS 304 transistor is coupled to the source of the PMOS 302 transistor. Accordingly, at higher voltages, the PMOS 304 transistor behaves like a resistor, thereby providing an additional drop in voltage to the PMOS 208 transistor. The output voltage of the PMOS 208 transistor is therefore provided by the following relationship:
V_{SG}(device 208)=V_{CC}−V_{SG}(device 302)−I.R(device 304) equation (2)
where “I” is the biasing current in the pulldown stack of the comparator final output driver. Moreover, R is the resistance of the PMOS 304 transistor. Accordingly, the output voltage no longer varies rail to rail but rather varies between V_{CC} and the value given by equation (2).

The switching circuit 120 and the current control circuit 130 both comprise PMOS transistors, e.g., PMOS 302 and 304 respectively. It is appreciated that the 1 5 use of two PMOS transistors is beneficial, e.g., PMOS 302 and 304, because the use of same types of transistors enables the transistors to drift together and thereby track one another with the switch transistor 208. It is appreciated, however, that in other embodiments the PMOS 302 transistor of the switching circuit 120 may be replaced by an n-type metal oxide semiconductor (NMOS) transistor (not shown). In 20 one embodiment where an NMOS transistor is used instead of the PMOS 302 transistor, the drain of the NMOS transistor may be coupled to the drain of the PMOS 304 transistor and the gate and the source of the NMOS transistor may be coupled to the gate 207 of the PMOS 208 transistor.

It is appreciated that the current control circuit 130 as described above is active at all voltage ranges. In one embodiment, the current control activation circuit 140 may be coupled to the current control circuit 130 in order to activate the current control circuit 130 when the supply voltage is greater than a given threshold. For example, the current control activation circuit 140 may activate the current control circuit 130 when the supply voltage, e.g., V_{CC}, is greater than a given threshold, e.g., 0.5 volt plus the threshold voltage of the PMOS 304 transistor.

In one embodiment of the present invention, the current control activation circuit 140 comprise two resistor components in series, e.g., R₁ 306 and R₂ 308 respectively, which are further coupled to an NMOS transistor 310. In one embodiment, the activation signal 307 couples to the gate of the PMOS 304 transistor. The values of the two resistor components, 306 and 308, and the NMOS transistor 310 may be selected to control the V_{CC} value above which the rail to rail switching on node 207 stops and activates the current control.

According to one embodiment of the present invention, the gate of PMOS device 304 is coupled to the second terminal of resistor 308 at node 307. Resistor 306 couples node 307 to chassis ground. In one exemplary embodiment, the voltage at node 307 is about 0.5 volts plus the threshold voltage of the PMOS transistor. This voltage is derived by dividing the difference of threshold voltages of the NMOS 310 and a native NMOS by 2 with the help of resistors. Therefore, when the supply voltage, is greater than 0.5 volts the current control circuit 130 will be activated by turning on the PMOS 304 switch. In accordance with an alternative embodiment of the present invention, node 307 can be coupled to ground in order to limit overdrive at low voltages. By sliding node 307 on the resistor divider, overdrive limiting can be chosen to start above any V_{CC}.

Accordingly, the comparator output driver 206 controls, in part, the operation of PMOS device 208. Comparator output driver 206 is responsive to a comparison of V_{PWR} 202 and a known voltage reference, V_{ref} 204. It is appreciated that embodiments in accordance with the present invention are well suited to comparing a wide variety of reference voltages and scaled versions of a regulated output.

In order to advantageously reduce voltage ripple on the output of the voltage regulator circuit, e.g., on V_{PWR} 202, and in accordance with embodiments of the present invention, the resistance of PMOS device 208 is controlled. The resistance of PMOS device 208 is controlled by controlling the overdrive of PMOS device 208. The overdrive of PMOS device 208 is defined as the source-gate voltage minus the PMOS threshold voltage, V_{SG}−V_{THP}, wherein the threshold voltage is V_{SG}(device 208).

As a beneficial result, and in contrast with the conventional art, PMOS device 208 is no longer controlled rail to rail but instead at a value less than rail to rail as described by equations (1) and (2) above. For example, the gate of PMOS device 208, node 207, does not change from the supply voltage to ground. Rather, the node 207 varies between the supply voltage V_{CC} and a value given by equation 2, above.

Advantageously, such limiting of the voltage variation, or swing, at node 207, e.g., the control voltage of PMOS device 208, limits the variation of the charge rate through PMOS device 208. Such a reduced variation of the charge rate beneficially reduces ripple induced on to the regulated output, producing a desirably cleaner output. Furthermore, the variation in amount and/or frequency of ripple is reduced, enabling more effective filtering of any ripple that is present.

Accordingly, voltage variation and therefore ripple in the voltage regulator is controlled without being constrained by the size of the switch, e.g., headroom requirements, used by the comparator. Moreover, controlling ripple in the voltage regulator in accordance with embodiments of the present invention is achieved without using additional power. Accordingly, the voltage regulator in accordance with embodiments of the present invention are suitable for low power applications (e.g., battery operable). Additionally, since only a few transistors are added, manufacturing cost remains low while valuable die surface is conserved. Furthermore, since the amount of ripple is maintained for various supply voltages, the range of operation for the voltage regulator is increased for a given comparator speed.

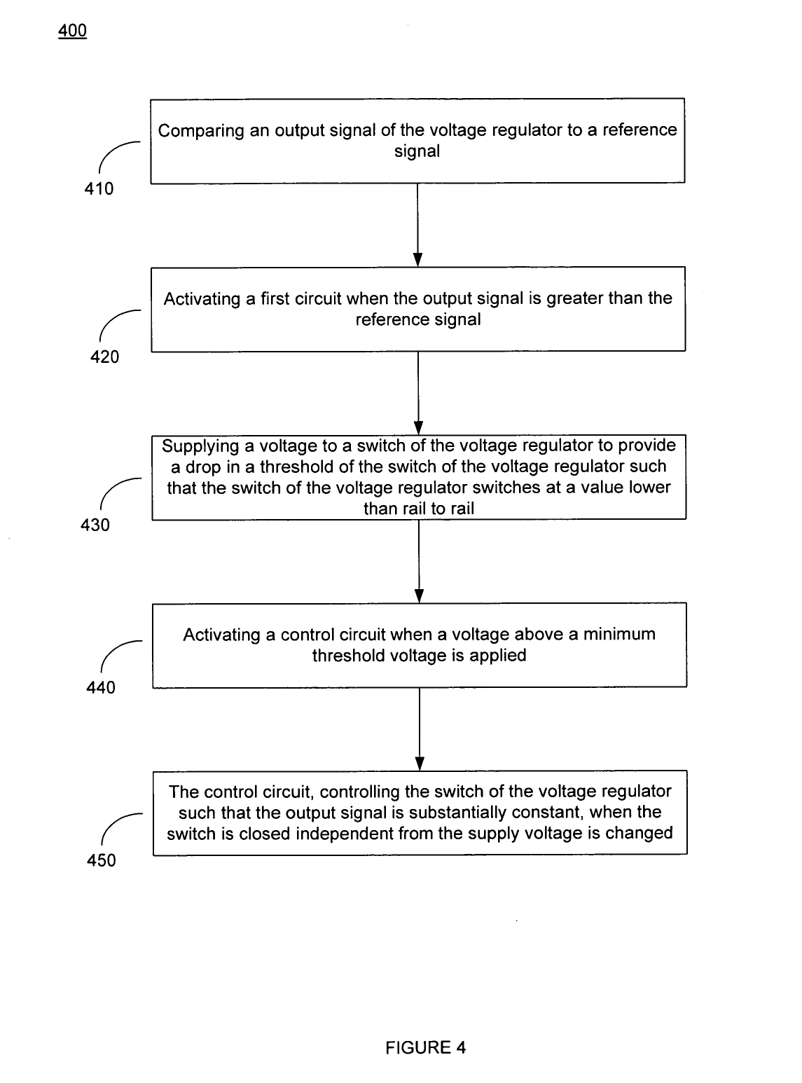

Referring now to FIG. 4, an exemplary flow diagram 400 for maintaining substantially a constant ripple in a voltage regulator in accordance with one embodiment of the present invention is shown. At step 410, the output voltage is compared to a reference voltage. At step 420, when the output voltage is greater than the reference voltage, a first circuit may be activated. It is appreciated that the first circuit according to step 420 may be the PMOS transistor 208 as described above.

As described above, switching PMOS transistor 208 provides a rail to rail output. Therefore, at step 430 when the PMOS transistor 208 is turned on, a voltage is supplied to the gate of the PMOS transistor 208 in order to provide a drop in a threshold voltage of the switch. Therefore, the PMOS transistor 208 switches at a value lower than rail to rail.

At step 440, when the supply voltage is greater than a given threshold voltage, the current control activation circuit 140 activates the current control circuit 130. At step 450, when the current control circuit is activated it behaves as a crude current source and supplies an additional drop in the voltage of the PMOS 208 transistor. Therefore, the switch operates at a value lower than rail to rail. Accordingly, the output voltage is substantially constant when PMOS 208 is closed independent from the supply voltage. Furthermore, the ripple is reduced and as a result produces a desirably cleaner output signal as described above.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A voltage regulator device comprising:
a first circuit comprising:
a comparator for making a comparison of an output signal to a reference signal; and
a first switch coupled to said comparator for switching responsive to said comparison; and
a second circuit, coupled to said first circuit, for controlling said first circuit to switch at a value smaller than rail to rail.

2. The voltage regulator device as described in claim 1, wherein said second circuit is operable to provide a drop in a threshold voltage of said first switch to switch said first circuit at a value smaller than rail to rail.

3. The voltage regulator device as described in claim 1, wherein said second circuit comprises a p-type metal oxide semiconductor (PMOS) transistor.

4. The voltage regulator device as described in claim 1, wherein said second circuit comprises an n-type metal oxide semiconductor (NMOS) transistor.

5. The voltage regulator device as described in claim 1, wherein said first switch comprises a p-type metal oxide semiconductor (PMOS) transistor.

6. A voltage regulator device comprising:
a first circuit comprising:
a comparator for making a comparison of an output signal to a reference signal; and
a first switch coupled to said comparator for switching responsive to said comparison;
a second circuit, coupled to said first circuit, for controlling said first circuit to switch at a value smaller than rail to rail; and
a third circuit, coupled to said second circuit, for switchably controlling the resistance of said third circuit to control said output signal such that said output signal remains substantially constant, when said first switch is closed, independent from the supply voltage of said first switch.

7. The voltage regulator device as described in claim 6, wherein said second circuit is operable to provide a drop in a threshold voltage of said first switch to switch said first circuit at a value smaller than rail to rail.

8. The voltage regulator device as described in claim 6, wherein said second circuit comprises a p-type metal oxide semiconductor (PMOS) transistor.

9. The voltage regulator device as described in claim 6, wherein said second circuit comprises an n-type metal oxide semiconductor (NMOS) transistor.

10. The voltage regulator device as described in claim 6, wherein said first switch comprises a p-type metal oxide semiconductor (PMOS) transistor.

11. The voltage regulator device as described in claim 6, wherein the resistance of said third circuit decreases when said supply voltage of said first switch increases such that said third circuit operates as a current source.

12. The voltage regulator device as described in claim 6, wherein said third circuit comprises a p-type metal oxide semiconductor (PMOS) transistor.

13. The voltage regulator device as described in claim 6 further comprising:
a fourth circuit, coupled to said third circuit, operable to control activation of said third circuit at a voltage above a minimum threshold voltage.

14. The voltage regulator device as described in claim 13, wherein said fourth circuit comprises an n-type metal oxide semiconductor (NMOS) transistor coupled to a plurality of resistor components, wherein values of said NMOS transistor and said plurality of resistor components are operable to set said threshold which activates said third circuit.

15. A method of maintaining substantially a constant ripple in a voltage regulator, said method comprising:
comparing an output signal of said voltage regulator to a reference signal;
in response to said comparing, activating a first circuit when said output signal is greater than said reference signal; and
in response to said activation of said first circuit, supplying a voltage to a switch of said voltage regulator, wherein said supplied voltage to said switch of said voltage regulator provides a drop in a threshold of said switch of said voltage regulator such that said switch of said voltage regulator switches at a value smaller than rail to rail.

16. The method as described in claim 15, wherein said first circuit comprises a p-type metal oxide semiconductor (PMOS) transistor.

17. The method as described in claim 15, wherein said first circuit comprises an n-type metal oxide semiconductor (NMOS) transistor.

18. The method as described in claim 15 further comprising:
controlling said switch of said voltage regulator, using a control circuit, such that said output signal is substantially constant, when said switch of said voltage regulator is closed, independent from the supply voltage of said switch of said voltage regulator.

19. The method as described in claim 18 further comprising:
activating said control circuit at a voltage above a minimum threshold voltage.

20. The method as described in claim 19, wherein said minimum threshold voltage is changed by changing the resistance of a switch coupled to said control circuit.

21. The method as described in claim 18, wherein said control circuit comprises a p-type metal oxide semiconductor (PMOS) transistor.
